(19) United States
(12) Patent Application Publication
(10) Pub. No.: US 2026/0042461 A1
(43) Pub. Date: Feb. 12, 2026

(54) SELECTIVE LEARNING BY PREDICTION FOR DRIVING

(71) Applicant: AUTOBRAINS TECHNOLOGIES LTD, Tel Aviv-Yafo (IL)

(72) Inventors: Igal RAICHELGAUZ, Tel Aviv (IL); Julius ENGELSOY, Tel-Aviv,Yafo (IL)

(73) Assignee: AUTOBRAINS TECHNOLOGIES LTD, Tel Aviv-Yafo (IL)

(21) Appl. No.: 18/800,751

(22) Filed: Aug. 12, 2024

Related U.S. Application Data
(63) Continuation of application No. 18/800,477, filed on Aug. 12, 2024.

(51) Int. Cl. B60W 60/00; G06F 40/284; G06N 3/02

(52) U.S. Cl. CPC B60W 60/001; G06F 40/284; G06N 3/02

(57) ABSTRACT

A method of providing selective learning by prediction for driving, the method includes (a) obtaining, by a machine learning process using an artificial neural network trained across road elements, a first set of tokens with respect to an element captured in a sensed information unit in an environment of a vehicle, the first set of tokens representing respective attributes characterizing the first element; (b) obtaining, by the machine learning process, a second set of tokens generated respect to the vehicle and representing respective attributes characterizing the vehicle; (c) obtaining, by the machine learning process, a scenario indication that is indicative of a scenario faced by the vehicle in the environment; and (d) processing, by the machine learning process, the first set of tokens in correspondence with the second set of tokens and with respect to the scenario.

### BACKGROUND

Vehicles with autonomous driving capabilities and/or driver assistance capabilities are required to process in real time information regarding one or more road elements and to respond accordingly.

There is a growing need to improve the processing of information regarding road elements.

### SUMMARY

A method, system and non-transitory computer readable medium as illustrated in the application.

### A BRIEF DESCRIPTION OF THE DRAWINGS

The embodiments of the disclosure will be understood and appreciated more fully from the following detailed description, taken in conjunction with the drawings in which:

FIG. 1 illustrates an example of a vehicle;

FIG. 2 illustrates an example of a method;

FIG. 3 illustrates an example of a method;

FIG. 4 illustrates an example of a method;

FIG. 5 illustrates an example of a method;

FIG. 6 illustrates an example of a method;

FIG. 7 illustrates an example of a method;

FIG. 8 illustrates an example of a method;

FIG. 9 illustrates an example of a method; and

FIG. 10 illustrates other examples related to the tokens.

### DETAILED DESCRIPTION

The different figures illustrates examples of units and/or software and/or information items and/or steps and/or components. These examples are provided for brevity of explanation. At least one of the units and/or software and/or information items and/or steps and/or components is optional or mandatory.

According to an embodiment there are provided one or more methods, one or more non-transitory computer readable media and one or more computerized systems for processing information about the environment of a vehicle—especially tokens associated with road elements within the environment—in an accurate and/or resource saving manner. The amount of saving may range between 10-1000 percent—and even more.

According to an embodiment the one or more methods, one or more non-transitory computer readable media and one or more computerized systems use one or more machine learning processes that involve using transformers-—for driving related application that differ from natural language processing (NLP). A transformer neural network is a type of deep learning model that has been highly successful in natural language processing (NLP) tasks such as language translation, text summarization, and question answering. The key components of a transformer are (i) an Encoder-Decoder Architecture that includes an encoder that processes the input data and generates an internal representation, and a decoder that takes this internal representation and generates the output data, (ii) self-attention mechanism that allows the model to weigh the importance of different words in a sentence when encoding a single word. For each word in the input, self-attention calculates how much focus to place on every other word in the sentence, and (iii) Positional Encoding that is used to give the model information about the position of words in the sentence. The attention mechanism (also referred to as self-attention mechanism) is a key component of the transformer architecture and can be broken down into the following steps: (a) input Embeddings: Each word in the input sentence is converted into a fixed-size vector, (b) Query, Key, and Value Vectors—Each input embedding is linearly transformed into three vectors: Query (Q), Key (K), and Value (V), and (c) Attention Scores-the attention score for a word is computed as the dot product of the query vector of that word with the key vectors of all other words. This results in a score that represents how much focus should be placed on each word relative to the current word. These scores are often scaled by the square root of the dimension of the key vectors and then passed through a softmax function to get a probability distribution. (d) Weighted sum-the output for each word is computed as a weighted sum of the value vectors, where the weights are the attention scores. Transformers have revolutionized NLP by enabling models to handle complex language tasks with high accuracy and efficiency.

According to an embodiment the tokens fed to the transformer are related to road objects and are not limited to NLP tokens. The attention mechanism (including the positional encoding) is used for learning the relationship between different tokens.

According to an embodiment there are provided one or more methods that generate and/or uses multiple tokens per road element. The multiple tokens per road element may be a set of tokens or a sub-set of tokens selected out of the set. There may be any number of tokens per road element—for example between 2 and 10, between 11 and 100, and the like. According to an embodiment different classes of road elements are provided with the same number of tokens.

According to an embodiment, road elements of different classes are associated with different numbers of tokens. According to an embodiment, the relevancy of tokens are learnt and irrelevant tokens are omitted—which may result in having different numbers of tokens for different road elements.

According to an embodiment, different tokens are associated with different attributes of the road element.

According to an embodiment, one or more tokens are classification tokens that indicate the class of a road element—at one or more resolutions—for example a pedestrian, a vehicle, a lane border, a traffic signal, a two wheel vehicle, a four wheel vehicle, a car, a truck, a bicycle, a motorcycle, a scooter, a toddler, and the like.

According to an embodiment, one or more tokens are location tokens indicative of the location of the road element. The location may be provided at one or more resolutions—for example an exact coordinate, a location within a road segment, a location defined by a neighborhood, or a town, or a county, or a country, or a state or a continent.

According to an embodiment, one or more tokens are behavioral tokens indicative of the behavior of the road element-such as one or more typical behaviors of the road element under one or more scenarios.

According to an embodiment, a behavior token is indicative of at least one kinetic value—such as speed, acceleration, direction of progress, duration of progress, and the like.

According to an embodiment, a road element may be of an unclassified class or otherwise be unclassified. Even so-the road element may be identified using one or more other tokens such as behavior tokens indicative of a behavior of the road element. Alternatively-an unclassified road element may not be associated with a classification token.

According to an embodiment the road elements is identified (even of not classified) sing a segmentation process such as panoptic segmentation which is a complex computer vision task that solves both instance segmentation and semantic segmentation problems together, enabling a more detailed understanding of a given scenario. Pixels that belong to a segment that is not classified may be identified as belonging to the segment.

According to an embodiment, a behavior token provide richer context-for example:
A. A measure of adhering of the road element with road lanes (for example a percentage of time the road element maintains within a lane, an average distance from the center of the lane or from any lane border, and the like).
B. A measure of aggressiveness of the road element-for example an indication of a number of lane changes and/or an indication of accelerations and decelerations during driving, an indication of a distance between the road element and a vehicle in front of the ego vehicle.
C. A measure of consistency of driving pattern over time.
D. A measure of risk associated with the road element.

According to an embodiment, the attention scores associated with the tokens are learnt using imitation learning in which the machine learning process is trained to mimic the driving of an expert or a trusted driver.

According to an embodiment, the attention scores associated with the tokens are learnt using a predictive task in which the machine learning process is trained to estimate the further behavior of the road elements.

According to an embodiment the attention scores associated with the tokens are learnt by a machine learning process that uses a deep neural network such as a transformer. The learning process may include using at least one process out of imitation learning and a predictive task.

According to an embodiment, upon a completion of the training, the attention mechanism of the transformer provides attention scores to the different tokens—indicative of the relevancy of the tokens of the road users to the output of the machine learning process.

According to an embodiment, one or more transformer are trained to be responsive to different scenarios-and the attention scores are scenario specific—thereby providing an indication of a relevancy of tokens to different scenarios.

According to an embodiment, there are provided different narrow artificial intelligence agents that are associated with different scenarios—so that a given scenario is managed by a dedicated narrow artificial intelligence agent.

According to an embodiment, the scenarios are identified by the transformer or identified by a scenario detector other than the transformers.

According to an embodiment, the attention scores of a same token may differ from one scenario to the other.

According to an embodiment, a selection of a scenario virtually selects between tokens associated with the road element.

According to an embodiment, one or more tokens are scenario tokens indicative of the scenario—and the attention mechanism provides weights indicative of a relevancy of a road user to the different scenarios.

The usage of multiple tokens per road element enable to identify the relevant (attracting most attraction) tokens. The identification allows to focus on the relevant tokens and ignore irrelevant tokens—thereby simplifying the processing of the selected tokens, reduces the storage and processing resources allocated to the processing, increases the explainability of the outcome of the processing, and supports to display or otherwise explain to a human drive or passenger the essential road element(a) attributes.

The identification of scenarios and which tokens are relevant per scenario also simplifying the processing of the selected tokens, reduces the storage and processing resources allocated to the processing, increases the explainability of the outcome of the processing, and supports to display or otherwise explain to a human drive or passenger the essential road element(a) attributes.

Using multiple tokens per road element allows to learn the interaction between different tokens—instead of learning the interaction between road elements—which provides a more accurate processing.

According to an embodiment, the attention scores of tokens are indicative of contributions of other tokens—and can be analyzed to find the contribution of each other token and to the relationship (for example interaction) between different road elements.

According to an embodiment, the usage of behavioral tokens—to identify a road element—even if unclassified-broadens the coverage of the solution—as it is not limited by classification constraints.

According to an embodiments—the attributes of road elements that are represented by the tokens are determined in any manner. For example—the attributes may be determined based on simulations, accidents root cause analysis, based on multiple sessions of training transformers with different groups of tokens—and selecting which tokens are more relevant, and the like.

According to an embodiment, the tokens are generated by a tokenizers that converts attributes to a high-dimensional vectors. A tokenizer may be a machine learning process or may differ from a machine learning process.

According to an embodiment, there is provided a method of providing a granular image level representation for driving, the method includes: obtaining a sensed information unit that captures a first element in an environment of a vehicle; generating, by a machine learning process, a first set of tokens for the first element each representing a respective attribute characterizing the first element in the environment; processing, by the machine learning process, the first set of tokens in association with at least a second set of tokens generated for a second element in the environment of the vehicle; determining, based on the processing, an interaction between the first element and the second element in the environment; and determining, based on the determined interaction, a driving related output with respect to the vehicle.

According to an embodiment, at least one token of the first set of tokens and at least one token of the second set of tokens includes classification information indicative of a classification detection with respect to the first element and the second element, respectively.

According to an embodiment, at least one token associated with the first element and with the second element includes a classification detection indication.

According to an embodiment, at least token associated with the first element and with the second element includes a behavioral indication.

According to an embodiment, at least one token associated with the first element and with the second element includes position data.

According to an embodiment, generating the first set of tokens is based on an identified scenario faced by the vehicle.

According to an embodiment, for a different scenario identified for the vehicle, the method comprising generating a set of tokens for the first element that are different from the first set of tokens in at least one representing attribute characterization.

According to an embodiment, the machine learning process is trained by a self-supervised learning process.

According to an embodiment, the driving related output being a driving prediction indicator.

According to an embodiment, the determining of the interaction between the first element and the second element comprises determining a spatial relationship and a kinematic relation between the first element and the second element.

According to an embodiment, processing, by the machine learning process, involves determining a contribution of each first token of the first set of token to each second token of the second set of tokens.

According to an embodiment, there is provided a method of providing a granular image level representation for driving in interaction with unknown elements, the method comprising: obtaining a sensed information unit that captures an unclassified element in an environment of a vehicle; generating, by a machine learning process trained using a neural network, a first set of tokens for the unclassified element each representing a respective attribute characterizing the uncharacterized element in the environment; processing, by the machine learning process, the first set of tokens in association with at least a second set of tokens generated in the environment of the vehicle; determining, based on the processing, an interaction between the unclassified element and the vehicle in the environment; and determining, based on the determined interaction, a driving related output with respect to the vehicle.

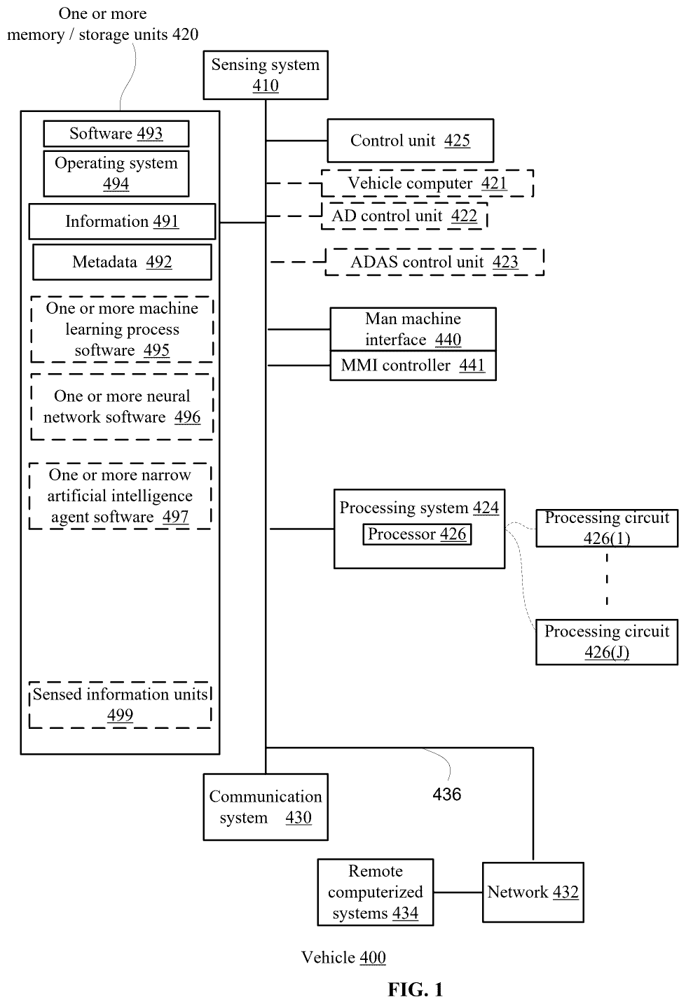

FIG. 1 illustrates an example of a vehicle 400.

Vehicle 400 includes a man machine interface 440 having or being in communication with man machine interface (MMI) controller 441, a communication system 430, one or more memory and/or storage units 420, a processing system 424 including processor 426. The communication system 430, the one or more memory and/or storage units 420, and the processing system 424 may belong to a computerized system of vehicle 400. The computerized system may be a server, a laptop, a desktop or any other computer and may include or be in communication with a sensing unit and/or a controller.

According to an embodiment, vehicle 400 is in communication with network 432 and one or more other remote computerized systems 434 that are in communication with network 432. An example of a remote computerized system is a server or one or more computers having access to a storage system that stores items related to one or more portions of one or more groups of neural networks—at least some of which are not currently stored in the vehicle.

According to an embodiment, the communication system 430 is configured to enable communication between the one or more memory and/or storage units 420 and/or any one of the additional units and/or the network 432 (that is in communication with the remote computerized systems). Communication system 430 is also configured to enable communication with other elements such as sensing system 410, man machine interface 440, control unit 425, vehicle computer 421, autonomous driving control unit 422 (denoted AD control unit), advanced driver assistance system (ADAS) control unit 423 (denoted ADAS control unit), and the like.

The memory and/or storage units 420 was shown as storing software. Any reference to software should be applied mutatis mutandis to code and/or firmware and/or instructions and/or commands, and the like.

Processor 426 includes a plurality of processing units 426(1)-426(J), J is an integer that exceeds one. Any reference to one unit or item should be applied mutatis mutandis to multiple units or items. For example—any reference to processor should be applied mutatis mutandis to multiple processors, any reference to communication system 430 should be applied mutatis mutandis to multiple communication systems.

According to an embodiment, the one or more memory and/or storage units 420 includes one or more memory unit, each memory unit may include one or more memory banks.

According to an embodiment, the one or more memory and/or storage units 420 includes a volatile memory and/or a non-volatile memory. The one or more memory and/or storage units 420 may be a random-access memory (RAM) and/or a read only memory (ROM).

According to an embodiment, the non-volatile memory unit is a mass storage device, which can provide non-volatile storage of computer code, computer readable instructions, data structures, program modules, and other data for the processor or any other unit of vehicle. For example, and not meant to be limiting, a mass storage device can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any content may be stored in any part or any type of the memory and/or storage units.

According to an embodiment, the at least one memory unit stores at least one database—such as any database known in the art—such as DB2®, Microsoft® Access, Microsoft® SQL Server, Oracle®, mySQL, PostgreSQL, and the like.

The memory and/or storage units 420 are configured to store firmware and/or software, one or more operating systems, data and metadata required to the execution of any of the methods mentioned in this application.

The memory and/or storage units 420 was shown as storing software. Any reference to software should be applied mutatis mutandis to code and/or firmware and/or instructions and/or commands, and the like.

Various units and/or components are in communication with each other using any communication elements and/or protocols. An example of a communication system is denoted 430. Other communication elements may be provided.

The communication system 430 may be in communication with bus 436. The bus represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus, and all buses specified in this description can also be implemented over a wired or wireless network connection and each of the subsystems.

Network 432 that is located outside the vehicle and is used for communication between the vehicle and at least one remote computing system. By way of example, a remote computing system can be a personal computer, a laptop computer, portable computer, a server, a router, a network computer, a peer device or other common network node, and so on. Logical connections between the processor and either one of remote computing systems can be made via a local area network (LAN) and a general wide area network (WAN). Such network connections can be through a network adapter (may belong to communication system 430) which can be implemented in both wired and wireless environments. Such networking environments are conventional and commonplace in offices, enterprise-wide computer networks, intranets, and a larger network such as the internet.

It should be noted that at least a part of the content illustrated as being stored in one or more memory/storage units 420 may be stored outside the vehicle. It should also be noted that the processor may evaluate signatures generated by a plurality of detectors.

Examples of generating signatures and/or cropping images are provided in U.S. patent application Ser. No. 18/527,701 which is incorporated herein by reference.

According to an embodiment, the memory and/or storage units 420 stores at least one of: operating system 494, information 491 such as sensed information units 499, metadata 492, and software 493 (such as one or more machine learning process software 495, one or more neural network software 496, one or more narrow artificial intelligence agent software 497) for executing one or more or all of method 300, method 330, method 340, method 900, method 920 or method 930.

FIG. 1 also illustrates information such as sensed information units 499-1.

The control unit 425 may cooperate with ADAS control unit 423 and/or with AD control unit 482 and/or may control or communicate with other vehicle components-including vehicle computer.

The ADAS control unit 423 is configured to control ADAS operations.

The AD control unit 422 is configured to control autonomous driving of the autonomous vehicle.

The vehicle computer 421 is configured to control the operation of the vehicle-especially controlling the engine, the transmission, and any other vehicle system or component.

The vehicle computer 421 may be in communication with an engine control module, a transmission control module, a powertrain control module, and the like.

The sensing system 410 may include optics, a sensing element group, a readout circuit, and an image signal processor. Optics are followed by a sensing element group such as line of sensing elements or an array of sensing elements that form the sensing element group. The sensing element group is followed by a readout circuit that reads detection signals generated by the sensing element group. An image signal processor is configured to perform an initial processing of the detection signals-for example by improving the quality of the detection information, performing noise reduction, and the like. The sensing system 410 is configured to output one or more sensed information units (SIUs).

Control unit 425 is configured to control the operation of the sensing system 410, and/or the one or more memory and/or storage units 420 and/or the one or more additional units (except the controller).

By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by a computer.

Any content may be stored in any part or any type of memory and/or storage units.

According to an embodiment, at least one memory unit stores at least one database-such as any database known in the art—such as DB2®, Microsoft® Access, Microsoft® SQL Server, Oracle®, mySQL, PostgreSQL, and the like.

Various units and/or components are in communication with each other using any communication elements and/or protocols. An example of a communication system is denoted 430. Other communication elements may be provided.

According to an embodiment, processing system 424 alone or in combination of any other unit illustrated above, is configured to perform, while executing software one or more or all of method 300, method 330, method 340, method 900, method 920 or method 930.

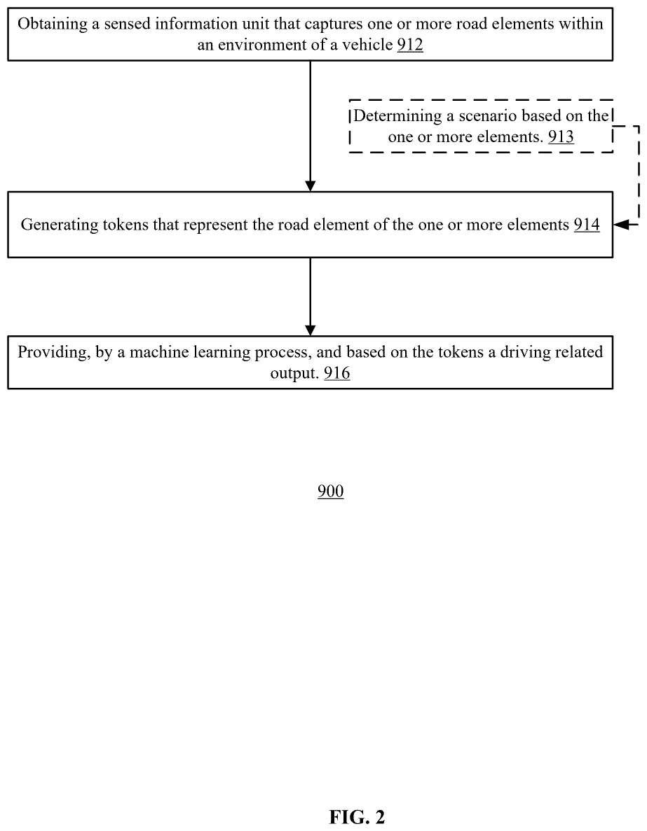

FIG. 2 illustrates an example of method 900 for providing driving related outputs.

According to an embodiment, method 900 includes step 912 of obtaining a sensed information unit that captures one or more road elements within an environment of a vehicle.

According to an embodiment, step 912 is followed by step 914 of generating tokens that represent the road element of the one or more elements. The tokens may be selected from a group of set of tokens associated with the road element.

According to an embodiment, step 914 is followed by step 916 of providing, by a machine learning process, and based on the tokens a driving related output.

The driving related output may include at least one of:
A. An instruction executable by a man machine interface controller, to provide a recommendation to a driver regarding a navigation of the vehicle.
B. A request aimed to the man machine interface controller, to provide a recommendation to a driver regarding a navigation of the vehicle.
C. An instruction executable by an autonomous control unit of the vehicle to perform an autonomous driving related operation such as autonomously changing a speed of the vehicle, autonomously changing an acceleration of the vehicle, autonomously changing an acceleration of the vehicle, autonomously changing a mode of operation of the vehicle.
D. A request aimed to an autonomous control unit of the vehicle to perform an autonomous driving related operation such as autonomously changing a speed of the vehicle, autonomously changing an acceleration of the vehicle, autonomously changing an acceleration of the vehicle, autonomously changing a mode of operation of the vehicle.
E. An instruction executable by a driver assistance control unit (such as but not limited to an ADAS control unit) of the vehicle to perform a driver assisting operation-such as suggesting to the driver a suggested path of progress, a suggested speed and/or acceleration and/or direction of the vehicle, or performing an autonomous braking operation or performing a lane maintenance operation of temporarily, during a short period, takeover the control of the vehicle, and the like.
F. A request aimed to a driver assistance control unit (such as but not limited to an ADAS control unit) of the vehicle to perform a driver assisting operation-such as suggesting to the driver a suggested path of progress, a suggested speed and/or acceleration and/or direction of the vehicle, or performing an autonomous braking operation or performing a lane maintenance operation of temporarily, during a short period, takeover the control of the vehicle, and the like.
G. An instruction executable by a computer vehicle related to a manner of operation of any component of the vehicle such as brakes, engine, and the like.
H. A request sent to a computer vehicle related to a manner of operation of any component of the vehicle such as brakes, engine, and the like.
I. Information about the environment of the vehicle.
J. A prediction of a future path of the vehicle.
K. A prediction of a behavior of one or more road element.
L. An emergency alert.
M. A collision alert.

The providing may include storing at a location accessible to another unit controller, transmitting the instructions to the other unit, sending an indication about the generation of the instructions to the other unit man machine interface controller.

According to an embodiment, the method may include outputting and/or transmitting an/or storing and/or instructing to respond to and/or triggering a response to and/or controlling a response to and/or performing a respond to any of the driving related output listed above and/or below.

According to an embodiment, the method may include generating and/or requesting and/or determining and/or instructing and/or triggering and/or controlling and/or transmitting and/or outputting and/or preforming at least one of a warning, an alert signal, a driving alert, an estimated future driving of the vehicle, an estimated future behavior (e.g. movement) of any road element, an autonomous driving operation, an driving assistance output, a prediction output with respect to the behavior (e.g. movement, etc) of the element in the environment—and/or in the environment with re to the vehicle, an operation and/or response in compliant with one or more levels of autonomous driving—such as L2, L2+, L2++, L3 or L4 autonomous driving.

According to an embodiment, method 900 further includes step 913 of determining a scenario based on the one or more elements. The determination can be made by the machine learning process or by another process.

According to an embodiment, the scenarios are identified by the transformer or identified by a scenario detector other than the transformers.

According to an embodiment, the attention scores of the same token may differ from one scenario to the other. According to an embodiment, a selection of a scenario virtually selects between tokens associated with the road element. According to an embodiment, one or more tokens are scenario tokens indicative of the scenario-and the attention mechanism provides weights indicative of a relevancy of a road user to the different scenarios.

An example of a detection of a situation is illustrated in U.S. patent application Ser. No. 16/729,589 which is incorporated herein by reference. Any reference in U.S. patent application Ser. No. 16/729,589 to a situation is applicable mutatis mutandis to a scenario.

Examples of scenarios include at least one of (a) a location of the vehicle, (b) one or more weather conditions, (c) one or more contextual parameters, (d) a road condition, (e) a traffic parameter. Various examples of a road condition may include the roughness of the road, the maintenance level of the road, presence of potholes or other related road obstacles, whether the road is slippery, covered with snow or other particles. Various examples of a traffic parameter and the one or more contextual parameters may include time (hour, day, period or year, certain hours at certain days, and the like), a traffic load, a distribution of vehicles on the road, the behavior of one or more vehicles (aggressive, calm, predictable, unpredictable, and the like), the presence of pedestrians near the road, the presence of pedestrians near the vehicle, the presence of pedestrians away from the vehicle, the behavior of the pedestrians (aggressive, calm, predictable, unpredictable, and the like), risk associated with driving within a vicinity of the vehicle, complexity associated with driving within of the vehicle, the presence (near the vehicle) of at least one out of a kindergarten, a school, a gathering of people, and the like. A contextual parameter may be related to the context of the sensed information—context may be depending on or relating to the circumstances that form the setting for an event, statement, or idea.

According to an embodiment, step 913 is followed by step 914 and the tokens generated are responsive to the scenario. Accordingly—step 914 includes selecting, based on the scenario, a sub-set of tokens out of a larger set of tokens associated with the road element.

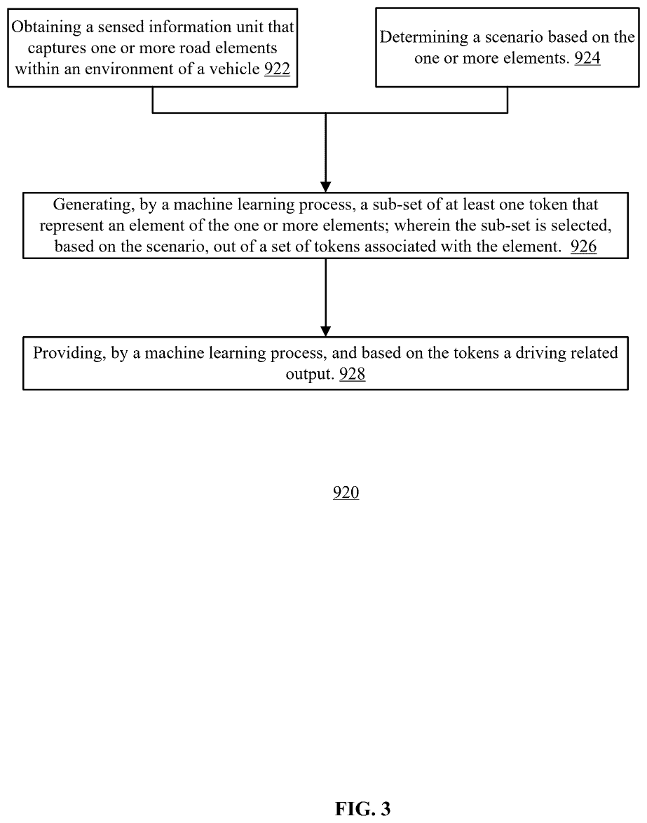

FIG. 3 illustrates an example of method 920 for providing driving related outputs.

According to an embodiment, method 920 includes steps 922 and 924.

According to an embodiment, step 922 includes obtaining a sensed information unit that captures one or more road elements within an environment of a vehicle.

According to an embodiment, step 924 includes determining a scenario based on the one or more elements. According to an embodiment, the scenarios are identified by the transformer or identified by a scenario detector other than the transformers. According to an embodiment, the attention scores of a same token may differ from one scenario to the other. According to an embodiment, a selection of a scenario virtually selects between tokens associated with the road element. According to an embodiment, one or more tokens are scenario tokens indicative of the scenario-and the attention mechanism provides weights indicative of a relevancy of a road user to the different scenarios. An example of a detection of a situation is illustrated in U.S. patent application Ser. No. 16/729,589 which is incorporated herein by reference. Any reference in said U.S. patent application to a situation is applicable mutatis mutandis to a scenario.

According to an embodiment, steps 922 and 924 are followed by step 926 of generating, by a machine learning process, a sub-set of at least one token that represent an element of the one or more elements; wherein the sub-set is selected, based on the scenario, out of a set of tokens associated with the element.

According to an embodiment, step 926 is followed by step 928 of providing, by the machine learning process, and based on the tokens, a driving related output.

The driving related output may include at least one of:
A. An instruction executable by a man machine interface controller, to provide a recommendation to a driver regarding a navigation of the vehicle.
B. A request aimed to the man machine interface controller, to provide a recommendation to a driver regarding a navigation of the vehicle.
C. An instruction executable by an autonomous control unit of the vehicle to perform an autonomous driving related operation such as autonomously changing a speed of the vehicle, autonomously changing an acceleration of the vehicle, autonomously changing an acceleration of the vehicle, autonomously changing a mode of operation of the vehicle.
D. A request aimed to an autonomous control unit of the vehicle to perform an autonomous driving related operation such as autonomously changing a speed of the vehicle, autonomously changing an acceleration of the vehicle, autonomously changing an acceleration of the vehicle, autonomously changing a mode of operation of the vehicle.
E. An instruction executable by a driver assistance control unit (such as but not limited to an ADAS control unit) of the vehicle to perform a driver assisting operation—such as suggesting to the driver a suggested path of progress, a suggested speed and/or acceleration and/or direction of the vehicle, or performing an autonomous braking operation or performing a lane maintenance operation of temporarily, during a short period, takeover the control of the vehicle, and the like.
F. A request aimed to a driver assistance control unit (such as but not limited to an ADAS control unit) of the vehicle to perform a driver assisting operation—such as suggesting to the driver a suggested path of progress, a suggested speed and/or acceleration and/or direction of the vehicle, or performing an autonomous braking operation or performing a lane maintenance operation of temporarily, during a short period, takeover the control of the vehicle, and the like.
G. An instruction executable by a computer vehicle related to a manner of operation of any component of the vehicle such as brakes, engine, and the like.
H. A request sent to a computer vehicle related to a manner of operation of any component of the vehicle such as brakes, engine, and the like.
I. Information about the environment of the vehicle.
J. A prediction of a future path of the vehicle.
K. A prediction of a behavior of one or more road element.
L. An emergency alert.
M. A collision alert.

According to an embodiment, the method may include outputting and/or transmitting an/or storing and/or instructing to respond to and/or triggering a response to and/or controlling a response to and/or performing a respond to any of the driving related output listed above and/or below.

According to an embodiment, the method may include generating and/or requesting and/or determining and/or instructing and/or triggering and/or controlling and/or transmitting and/or outputting and/or preforming at least one of a warning, an alert signal, a driving alert, an estimated future driving of the vehicle, an estimated future behavior (e.g. movement) of any road element, an autonomous driving operation, an driving assistance output, a prediction output with respect to the behavior (e.g. movement, etc) of the element in the environment-and/or in the environment with re to the vehicle, an operation and/or response in compliant with one or more levels of autonomous driving—such as L2, L2+, L2++, L3 or L4 autonomous driving.

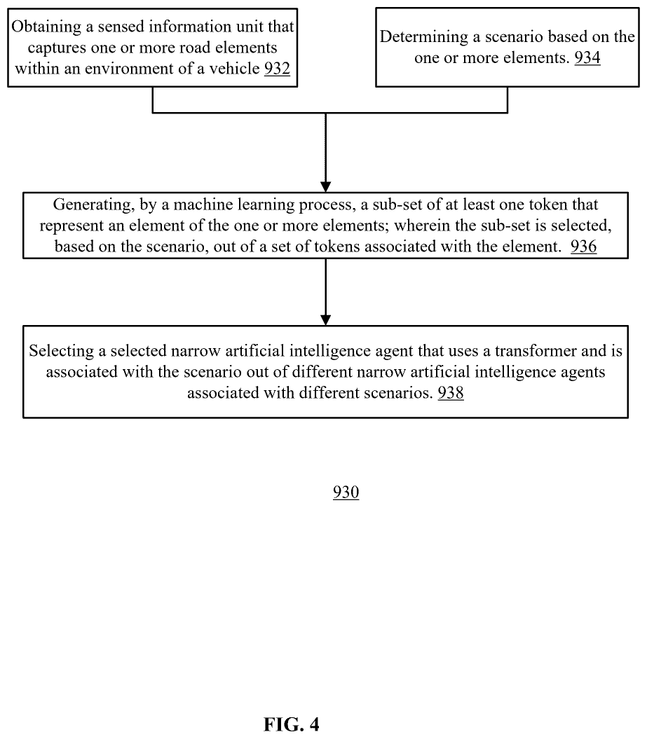

FIG. 4 illustrates an example of method 930 for providing driving related outputs.

According to an embodiment, method 930 includes steps 932 and 934.

According to an embodiment, step 932 includes obtaining a sensed information unit that captures one or more road elements within an environment of a vehicle.

According to an embodiment, step 934 includes determining a scenario based on the one or more elements. According to an embodiment, the attention scores of a same token may differ from one scenario to the other. According to an embodiment, a selection of a scenario virtually selects between tokens associated with the road element. According to an embodiment, one or more tokens are scenario tokens indicative of the scenario-and the attention mechanism provides weights indicative of a relevancy of a road user to the different scenarios. An example of a detection of a situation is illustrated in U.S. patent application Ser. No. 16/729,589 which is incorporated herein by reference. Any reference in said US patent application to a situation is applicable mutatis mutandis to a scenario.

According to an embodiment, steps 932 and 934 are followed by step 936 of selecting a selected narrow artificial intelligence agent that uses a transformer and is associated with the scenario out of different narrow artificial intelligence agents associated with different scenarios.

According to an embodiment, steps 936 is followed by step 938 of generating, by the selected machine learning process, and based on the tokens a driving related output.

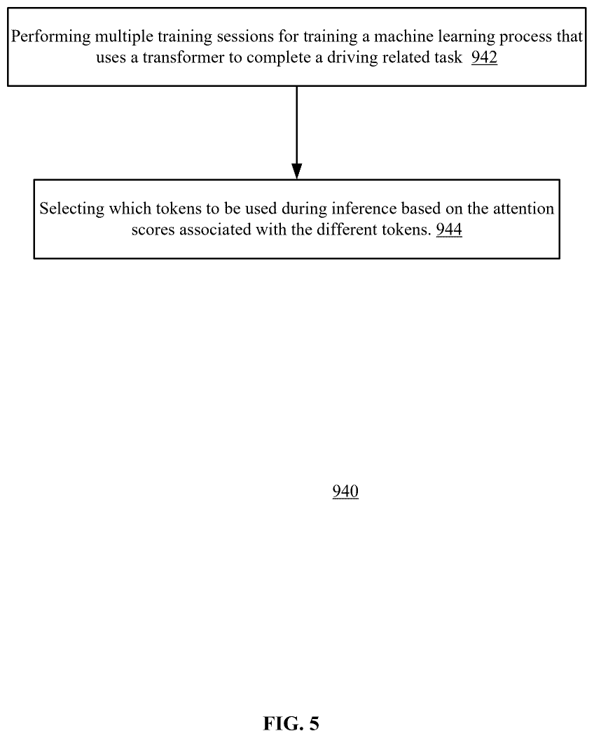

FIG. 5 illustrates an example of method 940 for identifying tokens of relevance.

According to an embodiment, method 940 includes step 942 of performing multiple training sessions for training a machine learning process that uses a transformer to complete a driving related task. Different training sessions differ from each other by the tokens that are fed to the machine learning process.

According to an embodiment, step 942 is followed by step 944 of selecting which tokens to be used during inference based on the attention scores associated with the different tokens. The most relevant tokens (according to their attention scores—for example having the attention scores of highest absolute value)—are selected.

According to an embodiment the selection of the tokens is done after the completion of one or some of the multiple training sessions so that the tokens used on a training session are selected in part based on attention scores applied during one or more previous training sessions.

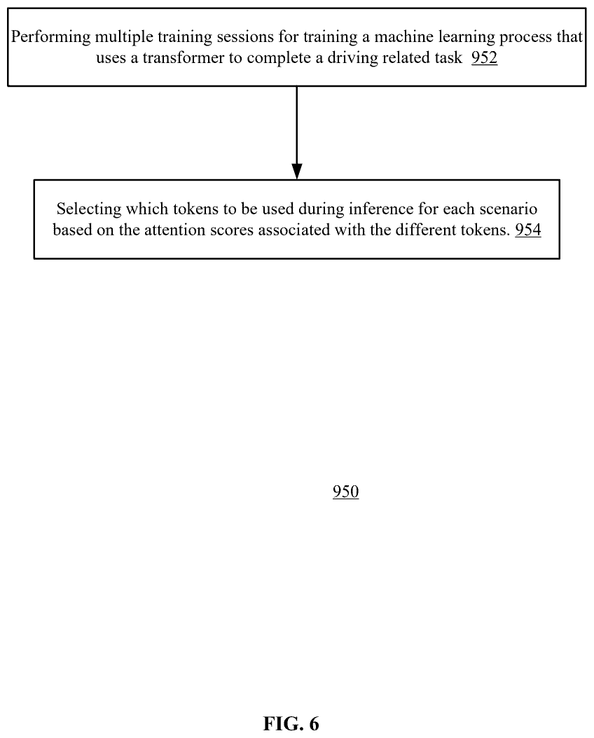

FIG. 6 illustrates an example of method 950 for identifying tokens of relevance.

According to an embodiment, method 950 includes step 952 of performing multiple training sessions for training a machine learning process that uses a transformer to complete a driving related task. Different training sessions differ from each other by the scenarios faced by the vehicle.

According to an embodiment, step 952 is followed by step 954 of selecting which tokens to be used during each scenario-during inference based on the attention scores associated with the different tokens at different scenarios.

An example of narrow artificial intelligence agents is illustrated in U.S. patent applications number Ser. No. 17/817,928 and Ser. No. 18/036,150 of Raichelgauz et al which are incorporated herein by reference.

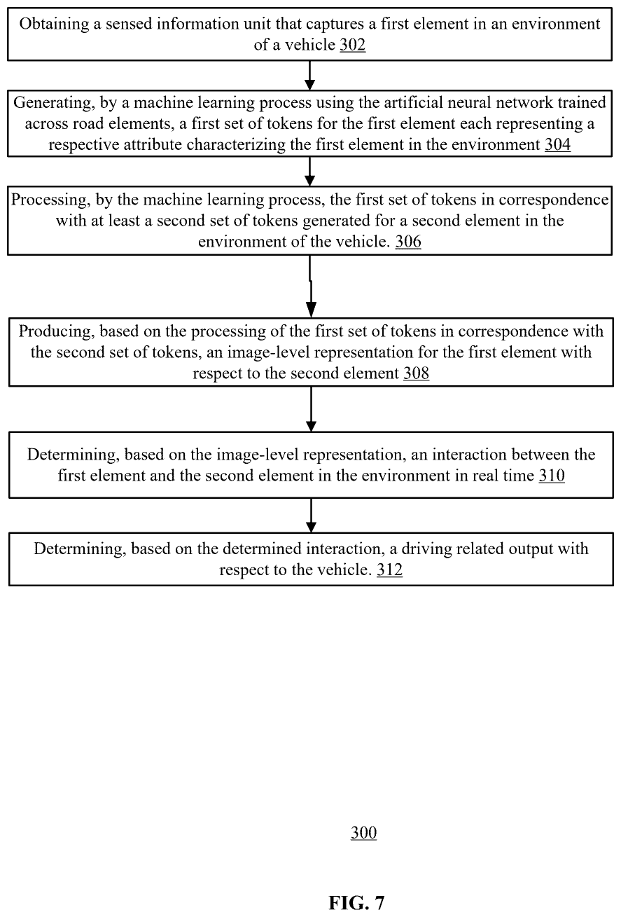

FIG. 7 illustrates an example of method 300 of using an artificial neural network to generate granular image level representations for driving.

According to an embodiment, method 300 includes step 302 of obtaining a sensed information unit that captures a first element in an environment of a vehicle.

According to an embodiment, step 302 is followed by step 304 of generating, by a machine learning process using the artificial neural network trained across road elements, a first set of tokens for the first element each representing a respective attribute characterizing the first element in the environment.

According to an embodiment, step 304 is followed by step 306 of processing, by the machine learning process, the first set of tokens in correspondence with at least a second set of tokens generated for a second element in the environment of the vehicle.

According to an embodiment, step 306 is followed by step 308 of producing, based on the processing of the first set of tokens in correspondence with the second set of tokens, an image-level representation for the first element with respect to the second element.

According to an embodiment, step 308 is followed by step 310 of determining, based on the image-level representation, an interaction between the first element and the second element in the environment in real time.

According to an embodiment, step 308 is followed by step 312 of determining, based on the determined interaction, a driving related output with respect to the vehicle.

According to an embodiment, the tokens of the first and/or second set of tokens may be classification tokens or behavioral tokens or provide richer contextual information.

According to an embodiment the processing includes applying a transformer on the first set of tokens and the second set of tokens to provide a transformer output.

According to an embodiment, the transformer output is a driving related output.

According to an embodiment, the transformer output is an intermediate result that is further processed, by the machine learning process or by another machine learning process or by a non-machine learning process, to provide the driving related output.

According to an embodiment, the intermediate result is indicative of an interaction between the first element and the second element in the environment.

According to an embodiment the intermediate result (indicative of an interaction between the first element and the second element in the environment) is further processed to determine, based on the determined interaction, a driving related output with respect to the vehicle. The processing may use a mapping between the interaction between the first and second sets of tokens and a driving related decision.

According to an embodiment the mapping is learnt during a training process (for example when applying imitation learning) in which a machine learning process trained to mimic the driving of an expert when facing such interactions—to provide the mapping between the interaction and the driving related decision.

According to an embodiment the mapping is learnt based on an outcome of a predictive task in which the machine learning process is trained to estimate the further behavior of the road elements—following the identified interaction, wherein the estimation is followed by determining (in a manner that can be learnt during training) how to react to the future behavior of the road elements—to provide the mapping between the interaction and the driving related decision.

According to an embodiment, at least one token of the first set of tokens and at least one token of the second set of is a classification token that includes classification information indicative of a classification detection with respect to the first element and the second element, respectively. According to an embodiment, at least one token associated with the first element and with the second element includes a classification detection indication.

According to an embodiment, at least token associated with the first element and with the second element is a behavioral token that includes a behavioral indication.

According to an embodiment, at least one token associated with the first element and with the second element is a location token—that includes position data.

According to an embodiment, generating the first set of tokens is based on an identified scenario faced by the vehicle. According to an embodiment, the scenarios are identified by the transformer or identified by a scenario detector other than the transformers. According to an embodiment, the attention scores of a same token may differ from one scenario to the other.

According to an embodiment, a selection of a scenario virtually selects between tokens associated with the road element. According to an embodiment, one or more tokens are scenario tokens indicative of the scenario—and the attention mechanism provides weights indicative of a relevancy of a road user to the different scenarios. An example of a detection of a situation is illustrated in U.S. patent application Ser. No. 16/729,589 which is incorporated herein by reference. Any reference in said US patent application to a situation is applicable mutatis mutandis to a scenario.

According to an embodiment, for a different scenario identified for the vehicle, method 300 includes generating a set of tokens for the first element that are different from the first set of tokens in at least one representing attribute characterization.

According to an embodiment, the machine learning process is trained by a self-supervised learning process.

According to an embodiment, the driving related output includes at least one of:
A. An instruction executable by a man machine interface controller, to provide a recommendation to a driver regarding a navigation of the vehicle.
B. A request aimed to the man machine interface controller, to provide a recommendation to a driver regarding a navigation of the vehicle.
C. An instruction executable by an autonomous control unit of the vehicle to perform an autonomous driving related operation such as autonomously changing a speed of the vehicle, autonomously changing an acceleration of the vehicle, autonomously changing an acceleration of the vehicle, autonomously changing a mode of operation of the vehicle.
D. A request aimed to an autonomous control unit of the vehicle to perform an autonomous driving related operation such as autonomously changing a speed of the vehicle, autonomously changing an acceleration of the vehicle, autonomously changing an acceleration of the vehicle, autonomously changing a mode of operation of the vehicle.
E. An instruction executable by a driver assistance control unit (such as but not limited to an ADAS control unit) of the vehicle to perform a driver assisting operation-such as suggesting to the driver a suggested path of progress, a suggested speed and/or acceleration and/or direction of the vehicle, or performing an autonomous braking operation or performing a lane maintenance operation of temporarily, during a short period, takeover the control of the vehicle, and the like.
F. A request aimed to a driver assistance control unit (such as but not limited to an ADAS control unit) of the vehicle to perform a driver assisting operation-such as suggesting to the driver a suggested path of progress, a suggested speed and/or acceleration and/or direction of the vehicle, or performing an autonomous braking operation or performing a lane maintenance operation of temporarily, during a short period, takeover the control of the vehicle, and the like.
G. An instruction executable by a computer vehicle related to a manner of operation of any component of the vehicle such as brakes, engine, and the like.
H. A request sent to a computer vehicle related to a manner of operation of any component of the vehicle such as brakes, engine, and the like.
I. Information about the environment of the vehicle.
J. A prediction of a future path of the vehicle.
K. A prediction of a behavior of one or more road element.
L. An emergency alert.
M. A collision alert.

According to an embodiment, the method may include outputting and/or transmitting an/or storing and/or instructing to respond to and/or triggering a response to and/or controlling a response to and/or performing a respond to any of the driving related output listed above and/or below.

According to an embodiment, the method may include generating and/or requesting and/or determining and/or instructing and/or triggering and/or controlling and/or transmitting and/or outputting and/or preforming at least one of a warning, an alert signal, a driving alert, an estimated future driving of the vehicle, an estimated future behavior (e.g. movement) of any road element, an autonomous driving operation, an driving assistance output, a prediction output with respect to the behavior (e.g. movement, etc) of the element in the environment—and/or in the environment with re to the vehicle, an operation and/or response in compliant with one or more levels of autonomous driving-such as L2, L2+, L2++, L3 or L4 autonomous driving.

According to an embodiment, by learning how the different road objects interact with each other, and with the ego vehicle, we get the “function semantics”, meaning indicative of the way the object, or road element is functioning, e.g. is positioned or moving, and optionally to predict how it will function (e.g. move, position, etc) in the future, in space, i.e. in the particular scenario.

According to an embodiment, the model processes the object information of a specified object, in a self-supervised learning process can give the model more information about its meaning so that it can associate the specified object with the correct meaning/intention of the object. Providing a narrow perception skill LLM-transformer based driving alert, or driving output for the vehicle.

According to an embodiment, the model is trained as a lean—narrow neural network able to indicate which qualities to care about-only relevant quantities in the scene—for narrow scenario. (vs. using all the information in the scene). E.g. by learning how relevant each object is for the driving.

According to an embodiment, for each narrow scenario (skill)—the LLM/transformer—is trained to produce a driving decision/policy for objects in the environment of the vehicle for this scenario at time ‘t’ or to predict its position in time ‘t+n’

For example—(a) In the specific scenario, object X at time t refers to ‘boy on sidewalk before zebra crossing’, while at a different time t+n the same object refers to ‘boy continue to walk along the sidewalk and away from zebra crossing’.

For example-In a first scenario (narrow perception task or scenario M), object XX refers to ‘a boy about to cross the street’, while in a second scenario (narrow perception skill N) the same object refers to ‘a schoolboy holding a stop sign for helping children cross the street’.

According to an embodiment, the determining of the interaction between the first element and the second element comprises determining a spatial relationship and a kinematic relation between the first element and the second element. The spatial relationship may be learned from location tokens of the first and second sets of tokens. The kinematic relationship may be learned from behavior tokens of the first and second sets of tokens.

According to an embodiment, processing, by the machine learning process, involves determining a contribution of each first token of the first set of token to each second token of the second set of tokens. The contribution may be detected based on the attention scores or based on another parameter.

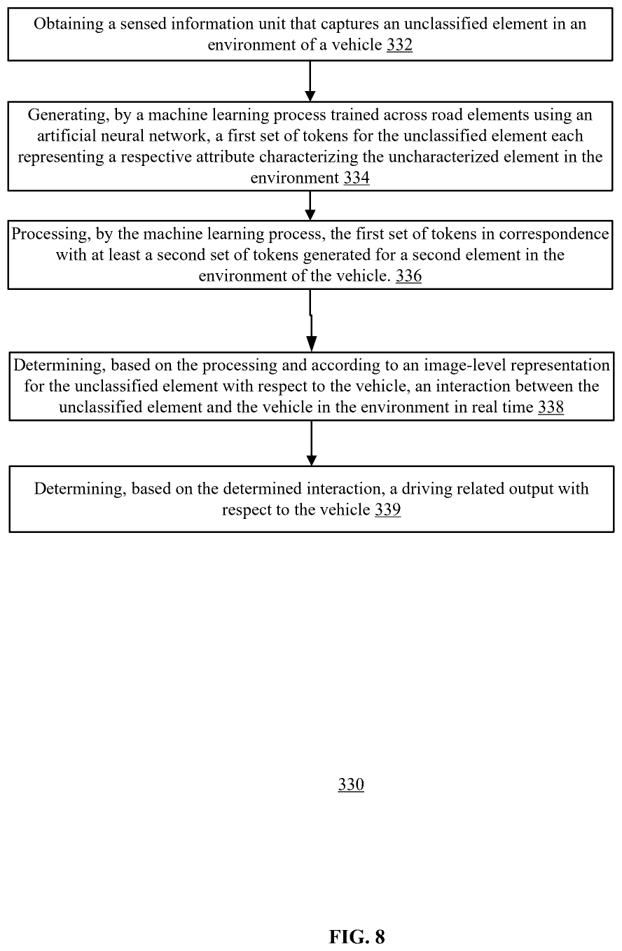

FIG. 8 illustrates an example of method 330 of providing a granular image level representation for driving in interaction with unknown elements.

According to an embodiment, method 330 includes step 332 of obtaining a sensed information unit that captures an unclassified element in an environment of a vehicle.

According to an embodiment, step 332 is followed by step 334 of generating, by a machine learning process trained across road elements using an artificial neural network, a first set of tokens for the unclassified element each representing a respective attribute characterizing the uncharacterized element (unclassified) in the environment.

According to an embodiment, step 334 is followed by step 336 of processing, by the machine learning process, the first set of tokens in correspondence with at least a second set of tokens generated in the environment of the vehicle.

According to an embodiment, step 336 is followed by step 338 of determining, based on the processing and according to an image-level representation for the unclassified element with respect to the vehicle, an interaction between the unclassified element and the vehicle in the environment in real time.

According to an embodiment, step 338 is followed by step 339 of determining, based on the determined interaction, a driving related output with respect to the vehicle.

According to an embodiment, the driving related output includes at least one of:
A. An instruction executable by a man machine interface controller, to provide a recommendation to a driver regarding a navigation of the vehicle.
B. A request aimed to the man machine interface controller, to provide a recommendation to a driver regarding a navigation of the vehicle.
C. An instruction executable by an autonomous control unit of the vehicle to perform an autonomous driving related operation such as autonomously changing a speed of the vehicle, autonomously changing an acceleration of the vehicle, autonomously changing an acceleration of the vehicle, autonomously changing a mode of operation of the vehicle.
D. A request aimed to an autonomous control unit of the vehicle to perform an autonomous driving related operation such as autonomously changing a speed of the vehicle, autonomously changing an acceleration of the vehicle, autonomously changing an acceleration of the vehicle, autonomously changing a mode of operation of the vehicle.
E. An instruction executable by a driver assistance control unit (such as but not limited to an ADAS control unit) of the vehicle to perform a driver assisting operation—such as suggesting to the driver a suggested path of progress, a suggested speed and/or acceleration and/or direction of the vehicle, or performing an autonomous braking operation or performing a lane maintenance operation of temporarily, during a short period, takeover the control of the vehicle, and the like.
F. A request aimed to a driver assistance control unit (such as but not limited to an ADAS control unit) of the vehicle to perform a driver assisting operation-such as suggesting to the driver a suggested path of progress, a suggested speed and/or acceleration and/or direction of the vehicle, or performing an autonomous braking operation or performing a lane maintenance operation of temporarily, during a short period, takeover the control of the vehicle, and the like.
G. An instruction executable by a computer vehicle related to a manner of operation of any component of the vehicle such as brakes, engine, and the like.
H. A request sent to a computer vehicle related to a manner of operation of any component of the vehicle such as brakes, engine, and the like.
I. Information about the environment of the vehicle.
J. A prediction of a future path of the vehicle.
K. A prediction of a behavior of one or more road element.
L. An emergency alert.
M. A collision alert.

According to an embodiment, the method may include outputting and/or transmitting an/or storing and/or instructing to respond to and/or triggering a response to and/or controlling a response to and/or performing a respond to any of the driving related output listed above and/or below.

According to an embodiment, the method may include generating and/or requesting and/or determining and/or instructing and/or triggering and/or controlling and/or transmitting and/or outputting and/or preforming at least one of a warning, an alert signal, a driving alert, an estimated future driving of the vehicle, an estimated future behavior (e.g. movement) of any road element, an autonomous driving operation, an driving assistance output, a prediction output with respect to the behavior (e.g. movement, etc) of the element in the environment-and/or in the environment with re to the vehicle, an operation and/or response in compliant with one or more levels of autonomous driving—such as L2, L2+, L2++, L3 or L4 autonomous driving.

According to an embodiment, the tokens of the second set of tokens may be classification tokens or behavioral tokens or provide richer contextual information. The tokens of the first set of tokens either do not include a classification token or have a classification token that represents an unclassified road element.

According to an embodiment the processing includes applying a transformer on the first set of tokens and the second set of tokens to provide a transformer output.

According to an embodiment, the transformer output is a driving related output.

According to an embodiment, the transformer output is an intermediate result that is further processed, by the machine learning process or by another machine learning process or by a non-machine learning process, to provide the driving related output.

According to an embodiment, the intermediate result is indicative of an interaction between the first element and the second element in the environment.

According to an embodiment the intermediate result (indicative of an interaction between the first element and the second element in the environment) is further processed to determine, based on the determined interaction, a driving related output with respect to the vehicle. The processing may use a mapping between the interaction between the first and second sets of tokens and a driving related decision.

According to an embodiment, the unclassified element is a portion appearing in an image.

According to an embodiment, each of the second set of tokens representing respective attributes characterizing the vehicle in the environment.

According to an embodiment, each of the second set of tokens representing respective attributes characterizing a second element in the environment.

According to an embodiment, where the unclassified element and the second element are both an image portion appearing in an image, the method includes segmenting the unclassified element separately from the second element in the image portion.

According to an embodiment, the determining of the interaction is based on a prediction indication of a movement of the unclassified element in the environment with respect to a driving of the vehicle.

According to an embodiment, the determining of the interaction is based on a prediction indication of a movement of the unclassified element with respect to another element affecting a driving of the vehicle in the environment.

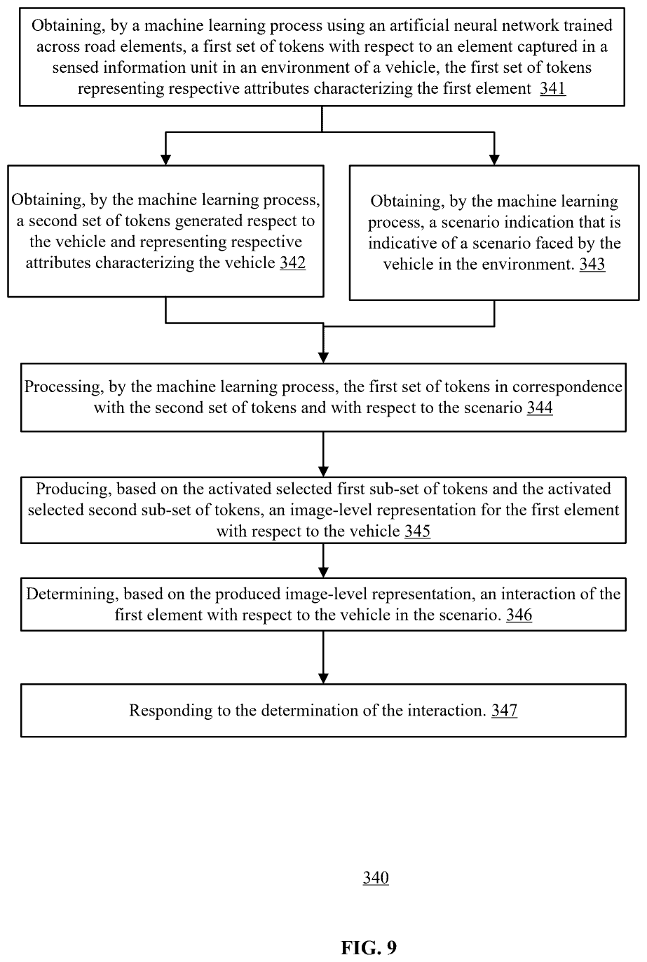

FIG. 9 illustrates an example of method 340 of providing a selective scenario level tokenization representation for driving.

According to an embodiment, method 340 includes step 341 of obtaining, by a machine learning process using an artificial neural network trained across road elements, a first set of tokens with respect to an element captured in a sensed information unit in an environment of a vehicle, the first set of tokens representing respective attributes characterizing the first element.

According to an embodiment, step 341 is followed by steps 342 and 343.

According to an embodiment, step 342 includes obtaining, by the machine learning process, a second set of tokens generated in respect to the vehicle and representing respective attributes characterizing the vehicle.

According to an embodiment, step 343 includes obtaining, by the machine learning process, a scenario indication that is indicative of a scenario faced by the vehicle in the environment.

According to an embodiment, steps 342 and 343 are followed by step 344 of processing, by the machine learning process, the first set of tokens in correspondence with the second set of tokens and with respect to the scenario, the processing comprising: selecting, based on the scenario indication, a sub-set of first tokens from the first set of tokens; selecting, based on the scenario indication, a second sub-set of second tokens from the second set of tokens; and activating the selected first sub-set of tokens and the selected second sub-set of tokens for the scenario.

According to an embodiment, the processing includes selecting, based on the scenario indication, a sub-set of tokens from the element set of tokens and the vehicle set of tokens, and activating the selected sub-set of tokens for the scenario.

According to an embodiment, step 344 is followed by step 345 of producing, based on the activated selected first sub-set of tokens and the activated selected second sub-set of tokens, an image-level representation for the first element with respect to the vehicle.

According to an embodiment, step 345 is followed by step 346 of determining, based on the produced image-level representation, an interaction of the first element with respect to the vehicle in the scenario.

According to an embodiment, the first machine learning process and the second machine learning process are different processes running on a same machine learning process.

According to an embodiment, step 346 is followed by step 347 of responding to the determination of the interaction.

According to an embodiment, step 347 includes determining, based on the determined interaction, a driving related output with respect to the vehicle.

According to an embodiment, the driving related output includes at least one of:
A. An instruction executable by a man machine interface controller, to provide a recommendation to a driver regarding a navigation of the vehicle.
B. A request aimed to the man machine interface controller, to provide a recommendation to a driver regarding a navigation of the vehicle.
C. An instruction executable by an autonomous control unit of the vehicle to perform an autonomous driving related operation such as autonomously changing a speed of the vehicle, autonomously changing an acceleration of the vehicle, autonomously changing an acceleration of the vehicle, autonomously changing a mode of operation of the vehicle.
D. A request aimed to an autonomous control unit of the vehicle to perform an autonomous driving related operation such as autonomously changing a speed of the vehicle, autonomously changing an acceleration of the vehicle, autonomously changing an acceleration of the vehicle, autonomously changing a mode of operation of the vehicle.
E. An instruction executable by a driver assistance control unit (such as but not limited to an ADAS control unit) of the vehicle to perform a driver assisting operation-such as suggesting to the driver a suggested path of progress, a suggested speed and/or acceleration and/or direction of the vehicle, or performing an autonomous braking operation or performing a lane maintenance operation of temporarily, during a short period, takeover the control of the vehicle, and the like.
F. A request aimed to a driver assistance control unit (such as but not limited to an ADAS control unit) of the vehicle to perform a driver assisting operation-such as suggesting to the driver a suggested path of progress, a suggested speed and/or acceleration and/or direction of the vehicle, or performing an autonomous braking operation or performing a lane maintenance operation of temporarily, during a short period, takeover the control of the vehicle, and the like.
G. An instruction executable by a computer vehicle related to a manner of operation of any component of the vehicle such as brakes, engine, and the like.
H. A request sent to a computer vehicle related to a manner of operation of any component of the vehicle such as brakes, engine, and the like.
I. Information about the environment of the vehicle.
J. A prediction of a future path of the vehicle.
K. A prediction of a behavior of one or more road element.
L. An emergency alert.
M. A collision alert.

According to an embodiment, the method includes outputting and/or transmitting an/or storing and/or instructing to respond to and/or triggering a response to and/or controlling a response to and/or performing a respond to any of the driving related output listed above and/or below.

According to an embodiment, the method includes generating and/or requesting and/or determining and/or instructing and/or triggering and/or controlling and/or transmitting and/or outputting and/or preforming at least one of a warning, an alert signal, a driving alert, an estimated future driving of the vehicle, an estimated future behavior (e.g. movement) of any road element, an autonomous driving operation, an driving assistance output, a prediction output with respect to the behavior (e.g. movement, etc) of the element in the environment-and/or in the environment with re to the vehicle, an operation and/or response in compliant with one or more levels of autonomous driving—such as L2, L2+, L2++, L3 or LA autonomous driving.

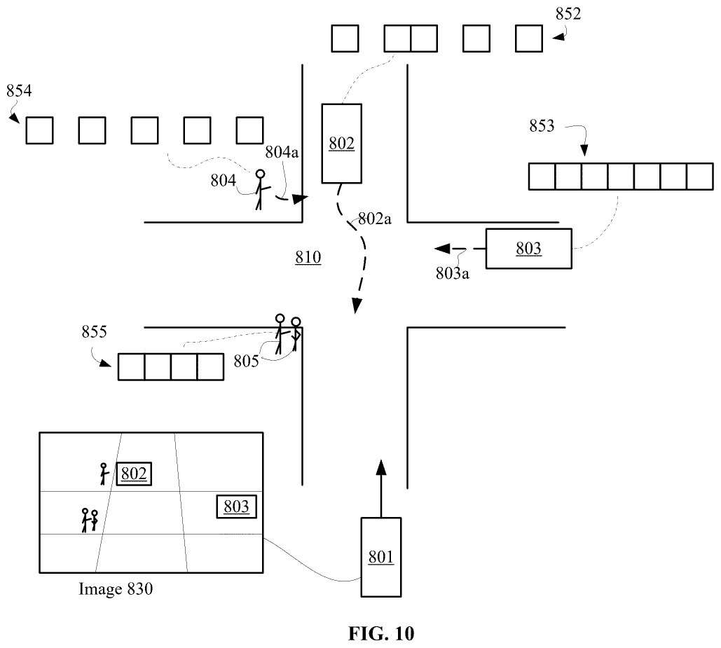

FIG. 10 illustrates a vehicle 801 that approaches a four way junction 810 and acquires an image 830 that captures:
A. First vehicle 802 associated with a first vehicle set of tokens 852 and with a first vehicle estimated future movement 802a.
B. Second vehicle 803 associated with a second vehicle set of tokens 853 and with a second vehicle estimated future movement 803a.
C. First pedestrian 804 associated with a first pedestrian set of tokens 854 and with a first pedestrian estimated future movement 804a
D. Pair of pedestrians 805 associated with a pair of pedestrians set of tokens 855 and with a pair of pedestrians estimated future movement (not shown) that indicates that the pair will not move in the near future.

For any road element—the tokens may represent their estimated future behavior.

The different road elements are illustrated as being associated with different number of tokens and/or different tokens.

The token of each set may be selected based on the situation and/or based on any other parameters—some of which were illustrated above.

Any combination of any step of any method illustrated in the application is provided.

In the foregoing detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarding the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any combination of any module or unit listed in any of the figures, any part of the specification and/or any claims may be provided.

The vehicle may be any type of vehicle—such as a ground transportation vehicle, an airborne vehicle, or a water vessel.

The specification and/or drawings may refer to an image. An image is an example of sensed information. Any reference to an image may be applied mutatis mutandis to any type of natural signal such as but not limited to signal generated by nature, signal representing human behavior, signal representing operations related to the stock market, a medical signal, financial series, geodetic signals, geophysical, chemical, molecular, textual and numerical signals, time series, and the like. Any reference to a media unit may be applied mutatis mutandis to sensed information. The sensed information may be of any kind and may be sensed by any type of sensors-such as a visual light camera, an audio sensor, a sensor that may sense infrared, radar imagery, ultrasound, electro-optics, radiography, LIDAR (light detection and ranging), etc. The sensing may include generating samples (for example, pixel, audio signals) that represent the signal that was transmitted, or otherwise reach the sensor.

The specification and/or drawings may refer to a processor. The processor may be a processing circuitry (also referred to as a processing circuit). The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

Any reference to an object may be applicable to a pattern. Accordingly-any reference to object detection is applicable mutatis mutandis to a pattern detection.

A situation may be a singular location, or optionally a combination of properties identified at a specified point in time. A scenario is a series of events that follow logically within a causal frame of reference. Any reference to a scenario should be applied mutatis mutandis to a situation.

The sensed information unit may be sensed by one or more sensors of one or more types. The one or more sensors may belong to the same device or system-or may belong to different devices of systems.

According to an embodiment any method illustrated in the application is applicable to one or more levels of autonomous driving-such as L2, L2+, L2++, L3 or L4 autonomous driving.

We claim

1. A method of providing selective learning by prediction for driving, the method comprising:
obtaining, by a machine learning process using an artificial neural network trained across road elements, a first set of tokens with respect to an element captured in a sensed information unit in an environment of a vehicle, the first set of tokens representing respective attributes characterizing the first element;
obtaining, by the machine learning process, a second set of tokens generated respect to the vehicle and representing respective attributes characterizing the vehicle;
obtaining, by the machine learning process, a scenario indication that is indicative of a scenario faced by the vehicle in the environment;
processing, by the machine learning process, the first set of tokens in correspondence with the second set of tokens and with respect to the scenario, the processing comprising: selecting, based on the scenario indication, a sub-set of first tokens from the first set of tokens; selecting, based on the scenario indication, a second sub-set of second tokens from the second set of tokens; and activating the selected first sub-set of tokens and the selected second sub-set of tokens for the scenario;
producing, based on the activated selected first sub-set of tokens and the activated selected second sub-set of tokens, an image-level representation for the first element with respect to the vehicle; and
determining, based on the produced image-level representation, an interaction of the first element with respect to the vehicle in the scenario.

2. The method of claim 1, further comprising activating the selected sub-set of tokens for determining a driving related output with respect to the vehicle.

3. The method of claim 1, wherein the first machine learning process and the second machine learning process are different processes running on a same machine learning process.

4. The method of claim 1, further comprising identifying the identified scenario, by the first machine learning process.

5. A non-transitory computer readable medium for selective learning by prediction for driving, the non-transitory computer readable medium stores instructions executable by a processing circuit for:
obtaining, by a machine learning process using an artificial neural network trained across road elements, a first set of tokens with respect to an element captured in a sensed information unit in an environment of a vehicle, the first set of tokens representing respective attributes characterizing the first element;
obtaining, by the machine learning process, a second set of tokens generated respect to the vehicle and representing respective attributes characterizing the vehicle;
obtaining, by the machine learning process, a scenario indication that is indicative of a scenario faced by the vehicle in the environment;
processing, by the machine learning process, the first set of tokens in correspondence with the second set of tokens and with respect to the scenario, the processing comprising: selecting, based on the scenario indication, a sub-set of first tokens from the first set of tokens; selecting, based on the scenario indication, a second sub-set of second tokens from the second set of tokens; and activating the selected first sub-set of tokens and the selected second sub-set of tokens for the scenario;
producing, based on the activated selected first sub-set of tokens and the activated selected second sub-set of tokens, an image-level representation for the first element with respect to the vehicle; and
determining, based on the produced image-level representation, an interaction of the first element with respect to the vehicle in the scenario

6. The non-transitory computer readable medium of claim 1, further stores instructions for activating the selected sub-set of tokens for determining a driving related output with respect to the vehicle.

7. The non-transitory computer readable medium of claim 1, wherein the first machine learning process and the second machine learning process are different processes running on a same machine learning process.

8. The non-transitory computer readable medium of claim 1, further stores instructions for identifying the identified scenario, by the first machine learning process.
